(19) United States
(12) Patent Application Publication
(10) Pub. No.: US 2025/0307985 A1
(43) Pub. Date: Oct. 2, 2025

(54) IMAGE PROCESSING APPARATUS, IMAGE PROCESSING METHOD, IMAGE PROCESSING PROGRAM, LEARNING DEVICE, LEARNING METHOD, LEARNING PROGRAM, AND ANALYSIS DEVICE

(71) Applicant: FUJIFILM CORPORATION, Tokyo (JP)

(72) Inventor: Akira KUDO, Tokyo (JP)

(21) Appl. No.: 19/089,014

(22) Filed: Mar. 25, 2025

(30) Foreign Application Priority Data
Mar. 26, 2024 (JP) 2024-049674

(51) Int. Cl. G06T 3/4007; G06T 3/4046

(52) U.S. Cl. CPC G06T 3/4007; G06T 3/4046

(57) ABSTRACT

A processor performs transfer learning on a first slice interpolation model for generating, in response to input of a two-dimensional image in a first expression format consisting of a plurality of slice images, the two-dimensional image being acquired by two-dimensionally imaging a first range of a subject, a pseudo three-dimensional image in the first expression format by performing slice interpolation on the two-dimensional image in the first expression format by using a three-dimensional image for learning in a second expression format acquired by three-dimensionally imaging a second range narrower than the first range, to construct a second slice interpolation model for generating, in response to input of a two-dimensional image in the second expression format, a pseudo three-dimensional image in the second expression format by performing slice interpolation on the two-dimensional image in the second expression format.

### CROSS REFERENCE TO RELATED APPLICATIONS

The present application claims priority from Japanese Patent Application No. 2024-049674, filed on Mar. 26, 2024, the entire disclosure of which is incorporated herein by reference.

### BACKGROUND

### Technical Field

The present disclosure relates to an image processing apparatus, an image processing method, an image processing program, a learning device, a learning method, a learning program, and an analysis device.

### Related Art

In a medical field, advances in various modalities, such as a computed tomography (CT) apparatus, a magnetic resonance imaging (MRI) apparatus, an ultrasound imaging apparatus, a positron emission tomography (PET) apparatus, and an X-ray imaging apparatus, have made it possible to perform image diagnosis using a medical image with higher quality. In such a modality, images having different slice intervals are acquired due to a difference in imaging method. For example, in a case in which three-dimensional imaging is performed, a three-dimensional image having a narrow slice interval is acquired. In a case in which two-dimensional imaging is performed, a two-dimensional image having a larger slice interval than the three-dimensional imaging is acquired. A difference between the two-dimensional image and the three-dimensional image is a difference in resolution in a direction perpendicular to a slice plane, and the three-dimensional image has a dense slice in the direction perpendicular to the slice plane, so that an anatomical structure can be recognized with high accuracy. On the other hand, since the two-dimensional image has a larger slice interval in the direction perpendicular to the slice plane than the three-dimensional image, the accuracy of reproducing the anatomical structure is lower than that of the three-dimensional image.

Therefore, a method of acquiring a pseudo three-dimensional image having a small slice interval by performing slice interpolation on a CT image acquired by two-dimensional imaging, in which the slice interval is larger than that in a case of performing three-dimensional imaging, is proposed (for example, see Akira Kudo et. al., Virtual Thin Slice: 3D Conditional GAN-based Super-resolution for CT Slice Interval, arXiv: 1908.11506 2 Sep. 2019). In addition, a method of performing slice interpolation of a limited part, such as a head, in an MRI image is also proposed (see, for example, Kuan Zhang et al., SOUP-GAN: Super-Resolution MRI Using Generative Adversarial Networks, arXiv: 2106.02599 4 Jun. 2021).

Incidentally, in a case of CT, since three-dimensional imaging is generalized for any part of a subject, a three-dimensional image having a dense slice interval is acquired for any part. However, for a case of MRI, although three-dimensional imaging is performed for specific parts such as a head, a knee, and a pelvis, two-dimensional imaging is generally performed for parts other than the specific parts. In order to acquire a three-dimensional image of parts other than such specific parts, it is considered to construct a model for deriving a three-dimensional image in a pseudo manner by performing slice interpolation on an MRI image acquired by two-dimensional imaging. However, since there are few three-dimensional images that are learning data for an MRI image of parts other than the specific parts, it is difficult to construct a model for deriving a three-dimensional image in a pseudo manner.

### SUMMARY OF THE INVENTION

The present disclosure has been made in view of the above circumstances, and an object of the present disclosure is to enable acquisition of a three-dimensional image in a pseudo manner.

According to the present disclosure, there is provided a learning device comprising: a processor, in which the processor performs transfer learning on a first slice interpolation model for generating, in response to input of a two-dimensional image in a first expression format consisting of a plurality of slice images, the two-dimensional image being acquired by two-dimensionally imaging a first range of a subject, a pseudo three-dimensional image in the first expression format by performing slice interpolation on the two-dimensional image in the first expression format by using a three-dimensional image for learning in a second expression format acquired by three-dimensionally imaging a second range narrower than the first range, to construct a second slice interpolation model for generating, in response to input of a two-dimensional image in the second expression format, a pseudo three-dimensional image in the second expression format by performing slice interpolation on the two-dimensional image in the second expression format.

According to the present disclosure, there is provided an image processing apparatus comprising: a processor, in which the processor uses the second slice interpolation model constructed by the learning device according to the present disclosure to derive the pseudo three-dimensional image in the second expression format from the two-dimensional image in the second expression format.

According to the present disclosure, there is provided a learning method comprising: causing a computer to execute performing transfer learning on a first slice interpolation model for generating, in response to input of a two-dimensional image in a first expression format consisting of a plurality of slice images, the two-dimensional image being acquired by two-dimensionally imaging a first range of a subject, a pseudo three-dimensional image in the first expression format by performing slice interpolation on the two-dimensional image in the first expression format by using a three-dimensional image for learning in a second expression format acquired by three-dimensionally imaging a second range narrower than the first range, to construct a second slice interpolation model for generating, in response to input of a two-dimensional image in the second expression format, a pseudo three-dimensional image in the second expression format by performing slice interpolation on the two-dimensional image in the second expression format.

According to the present disclosure, there is provided an image processing method comprising: causing a computer to execute using the second slice interpolation model constructed by the learning device according to the present disclosure to derive the pseudo three-dimensional image in the second expression format from the two-dimensional image in the second expression format.

According to the present disclosure, there is provided a learning program causing a computer to execute: a procedure of performing transfer learning on a first slice interpolation model for generating, in response to input of a two-dimensional image in a first expression format consisting of a plurality of slice images, the two-dimensional image being acquired by two-dimensionally imaging a first range of a subject, a pseudo three-dimensional image in the first expression format by performing slice interpolation on the two-dimensional image in the first expression format by using a three-dimensional image for learning in a second expression format acquired by three-dimensionally imaging a second range narrower than the first range, to construct a second slice interpolation model for generating, in response to input of a two-dimensional image in the second expression format, a pseudo three-dimensional image in the second expression format by performing slice interpolation on the two-dimensional image in the second expression format.

According to the present disclosure, there is provided an image processing program causing a computer to execute: a procedure of using the second slice interpolation model constructed by the learning device according to the present disclosure to derive the pseudo three-dimensional image in the second expression format from the two-dimensional image in the second expression format.

According to the present disclosure, it is possible to derive a three-dimensional image in a pseudo manner.

### BRIEF DESCRIPTION OF THE DRAWINGS

FIG. 1 is a hardware configuration diagram showing an outline of a diagnosis support system to which a learning device and an image processing apparatus according to an embodiment of the present disclosure are applied.

FIG. 2 is a diagram showing a hardware configuration of the learning device according to the present embodiment.

FIG. 3 is a diagram showing a functional configuration of the learning device according to the present embodiment.

FIG. 4 is a diagram for describing a first slice interpolation model.

FIG. 5 is a diagram for describing transfer learning for constructing a second slice interpolation model.

FIG. 6 is a diagram for describing swap of axes.

FIG. 7 is a diagram for describing a mask.

FIG. 8 is a diagram for describing transfer learning for constructing a second slice interpolation model.

FIG. 9 is a flowchart showing processing performed by the learning device according to the present embodiment.

FIG. 10 is a diagram showing a hardware configuration of the image processing apparatus according to the present embodiment.

FIG. 11 is a diagram showing a functional configuration of the image processing apparatus according to the present embodiment.

FIG. 12 is a flowchart showing processing performed by the image processing apparatus according to the present embodiment.

FIG. 13 is a diagram showing a hardware configuration of another learning device according to the present embodiment.

FIG. 14 is a diagram showing a functional configuration of the other learning device according to the present embodiment.

FIG. 15 is a diagram for describing training of a segmenter for constructing a segmentation model.

FIG. 16 is a flowchart showing processing performed by the other learning device according to the present embodiment.

### DETAILED DESCRIPTION

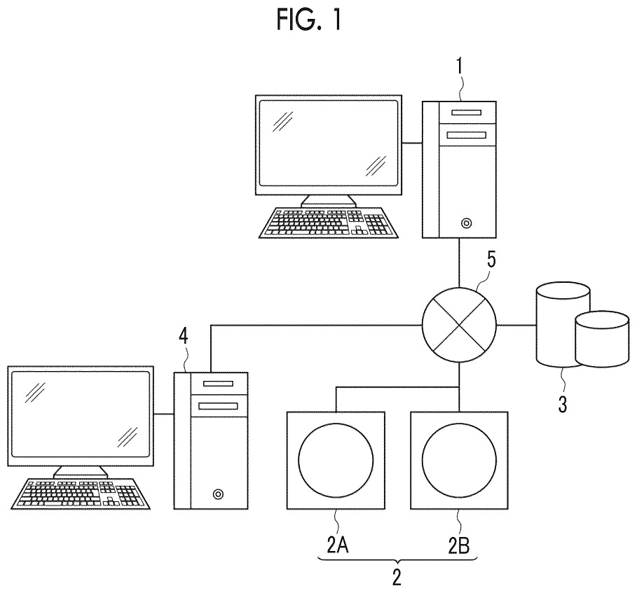

Hereinafter, an embodiment of the present disclosure will be described with reference to the drawings. FIG. 1 is a hardware configuration diagram showing an outline of a diagnosis support system to which an image processing apparatus and a learning device according to an embodiment of the present disclosure are applied. As shown in FIG. 1, in the diagnosis support system, a learning device 1, a modality 2, an image storage server 3, and an image processing apparatus 4 according to the present embodiment are connected to each other in a communicable state via a network 5.

The modality 2 is an apparatus that generates a two-dimensional image or a three-dimensional image representing a diagnosis target part of a subject by imaging the part, and specifically, is a CT apparatus, an MRI apparatus, an ultrasound imaging apparatus, a PET apparatus, an X-ray imaging apparatus, and the like. The image of the subject generated by the modality 2 is transmitted to the image storage server 3 and stored therein. In the present embodiment, it is assumed that the modality 2 includes a CT apparatus 2A and an MRI apparatus 2B.

The CT apparatus 2A and the MRI apparatus 2B can perform two-dimensional imaging and three-dimensional imaging, and a two-dimensional image is acquired by the two-dimensional imaging and a three-dimensional image is acquired by the three-dimensional imaging. In the present embodiment, both the three-dimensional image and the two-dimensional image include a tomographic image, but the three-dimensional image includes either or both of a plurality of tomographic images in which at least one of a slice interval or a slice thickness is smaller than that of the two-dimensional image and an image generated from the plurality of tomographic images in which each pixel is represented by three-dimensional coordinates. For example, the three-dimensional image includes a plurality of tomographic images in which at least one of a slice thickness or a slice interval is 5 mm or less.

Meanwhile, the two-dimensional image includes either or both of a plurality of tomographic images in which a slice interval is larger than that of the tomographic images included in the three-dimensional image and at least one or more tomographic images in which a slice thickness is larger than that of the tomographic images included in the three-dimensional image. The tomographic images include an image in which each pixel is represented by two-dimensional coordinates. In a case in which the three-dimensional image or the two-dimensional image is composed of a plurality of tomographic images, the tomographic images include position coordinates of each tomographic image in an imaging direction. Therefore, in the entire plurality of tomographic images, each pixel is represented by three-dimensional coordinates. The imaging direction is, for example, a direction perpendicular to a tomographic plane represented by the tomographic image.

The image storage server 3 is a computer that stores and manages various data, and comprises a large-capacity external storage device and database management software. The image storage server 3 communicates with another device via the wired or wireless network 5 and transmits and receives image data and the like. Specifically, the image storage server 3 acquires various data including image data of the image generated by the modality 2 via the network, and stores and manages the various data in a recording medium such as the large-capacity external storage device. A storage format of the image data and the communication between the respective devices via the network 5 are based on a protocol such as digital imaging and communication in medicine (DICOM). In addition, in the present embodiment, the image storage server 3 also stores and manages learning data and first slice interpolation model described below.

The learning device 1 and the image processing apparatus 4 according to the present embodiment are computers in which a learning program and an image processing program according to the present embodiment are respectively installed. The computer may be a workstation or a personal computer directly operated by a doctor performing diagnosis, or may be a server computer connected to them via a network. The learning program and the image processing program are stored in a storage apparatus of a server computer connected to the network or in a network storage in a state where the network storage can be accessed from an outside, and are downloaded to and installed on a computer used by a doctor upon request. Alternatively, the image processing program and the learning program are distributed by being recorded on a recording medium such as a digital versatile disc (DVD) or a compact disc read only memory (CD-ROM) and are installed on the computer from the recording medium.

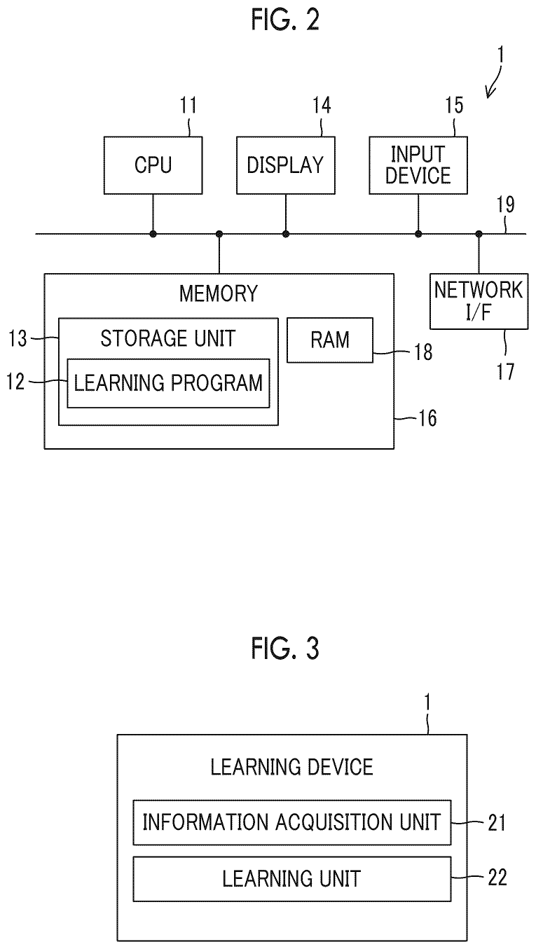

Hereinafter, the learning device according to the present embodiment will be described. FIG. 2 is a diagram showing a hardware configuration of the learning device according to the present embodiment. As shown in FIG. 2, the learning device 1 includes a central processing unit (CPU) 11, a display 14, an input device 15, a memory 16, and a network interface (I/F) 17 connected to the network 5. The CPU 11, the display 14, the input device 15, the memory 16, and the network I/F 17 are connected to a bus 19. The CPU 11 is an example of a processor in the present disclosure.

The memory 16 includes the storage unit 13 and a random access memory (RAM) 18. The RAM 18 is a memory for primary storage and is, for example, a RAM such as a static random access memory (SRAM) or a dynamic random access memory (DRAM).

The storage unit 13 is a non-volatile memory, and is implemented by at least one of, for example, a hard disk drive (HDD), a solid state drive (SSD), an electrically erasable and programmable read only memory (EEPROM), or a flash memory. A learning program 12 according to the present embodiment is stored in the storage unit 13 as a storage medium. The CPU 11 reads out the learning program 12 from the storage unit 13, loads the read-out learning program 12 into the RAM 18, and executes the loaded learning program 12.

The display 14 is a device that displays various screens and is, for example, a liquid crystal display or an electro luminescence (EL) display. The input device 15 is a device for a user to provide input and is, for example, at least any of a keyboard, a mouse, a microphone for voice input, a touchpad for proximity input including a contact, or a camera for gesture input. The network I/F 17 is an interface for connecting to the network 5.

Next, a functional configuration of the learning device according to the present embodiment will be described. FIG. 3 is a diagram showing the functional configuration of the learning device according to the present embodiment. As shown in FIG. 3, the learning device 1 comprises an information acquisition unit 21 and a learning unit 22. In a case in which the CPU 11 executes the learning program 12, the CPU 11 functions as the information acquisition unit 21 and the learning unit 22.

The information acquisition unit 21 acquires learning data and a first slice interpolation model for constructing a second slice interpolation model, which will be described below, through transfer learning from the image storage server 3 via the network 5. In the present embodiment, a three-dimensional MRI image acquired by three-dimensionally imaging a specific part of the subject by the MRI apparatus 2B is acquired as learning data. The three-dimensional MRI image acquired as the learning data is referred to as a three-dimensional MRI image for learning MR0. The three-dimensional MRI image for learning MR0 is an actual image that is actually acquired by the MRI apparatus 2B. Examples of the specific part include a head, a knee, and a pelvis of the subject, but the specific site is not limited to this. The MRI is an example of a second expression format of the present disclosure, the three-dimensional MRI image for learning MR0 is an example of a three-dimensional image for learning in a second expression format of the present disclosure, and the specific part is an example of a second range of the present disclosure.

In the present embodiment, the expression format of the image is an image expressed by an imaging method of the modality 2 that acquires the image. For example, the MRI image is an image expressed by an imaging method of the MRI apparatus. The image expressed by the imaging method includes at least one of an actual image that is actually captured by the modality 2 or a pseudo image that is derived in a pseudo manner by image processing.

The first slice interpolation model is a model for generating, in response to input of a two-dimensional image in a first expression format consisting of a plurality of slice images, the two-dimensional image being acquired by two-dimensionally imaging a first range of the subject, a pseudo three-dimensional image in a first expression format by performing slice interpolation on the two-dimensional image in the first expression format. In the present embodiment, for example, a first slice interpolation model constructed by the method disclosed in Akira Kudo et. al., Virtual Thin Slice: 3D Conditional GAN-based Super-resolution for CT Slice Interval, arXiv: 1908.11506 2 Sep. 2019 is used.

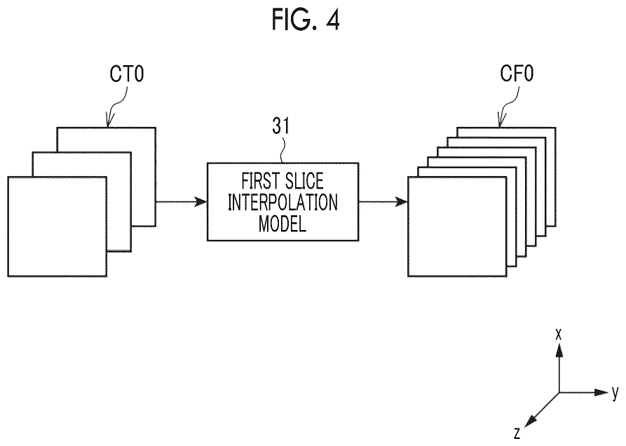

FIG. 4 is a diagram for describing the first slice interpolation model used in the present embodiment. As shown in FIG. 4, a first slice interpolation model 31 is a model for, in response to input of a two-dimensional CT image CTO acquired by two-dimensionally imaging the entire body of the subject using, for example, the CT apparatus 2A, generating a pseudo three-dimensional CT image CFO by performing slice interpolation on the two-dimensional CT image CTO. The first slice interpolation model 31 is composed of, for example, a convolutional neural network. The CT is an example of a first expression format of the present disclosure, the two-dimensional CT image CTO is an example of a two-dimensional image in the first expression format of the present disclosure, the entire body is an example of a first range of the subject of the present disclosure, and the pseudo three-dimensional CT image CFO is an example of a pseudo three-dimensional image in the first expression format of the present disclosure.

In the first slice interpolation model 31, as shown in FIG. 4, it is assumed that a z axis of three axes (x axis, y axis, and z axis) is set in a perpendicular to a slice plane in which the slice is interpolated. As a result, the first slice interpolation model 31 performs slice interpolation in a z axis direction for the input two-dimensional image.

The learning unit 22 performs transfer learning on the first slice interpolation model 31 using the three-dimensional MRI image for learning MR0 acquired by the information acquisition unit 21 to construct a second slice interpolation model for generating, in a case in which the two-dimensional MRI image acquired by imaging is input, a pseudo three-dimensional MRI image by performing slice interpolation on the two-dimensional MRI image.

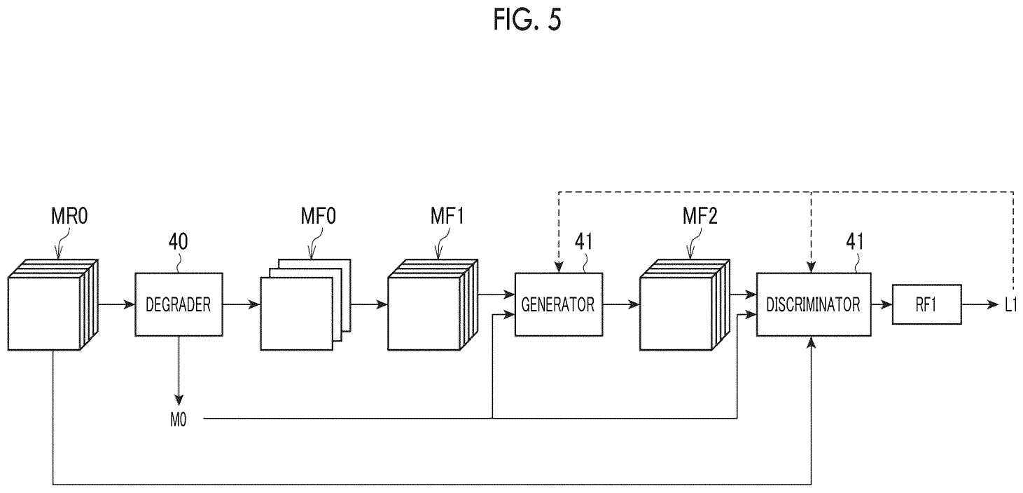

In the present embodiment, the learning unit 22 constructs the second slice interpolation model by performing transfer learning on the first slice interpolation model 31 through adversarial learning. In learning, the second slice interpolation model constitutes a generative adversarial network (GAN). FIG. 5 is a diagram for describing transfer learning for constructing the second slice interpolation model. As shown in FIG. 5, in order to construct the second slice interpolation model, in the present embodiment, a degrader 40, a generator 41, and a discriminator 42 are used. The generator 41 is the first slice interpolation model 31.

The degrader 40 derives a pseudo two-dimensional MRI image for learning MF0 in which the number of slices of the three-dimensional MRI image for learning MR0 is reduced. For this purpose, the degrader 40 blurs the three-dimensional MRI image for learning MR0 by performing, for example, filtering processing using a Gaussian filter in a direction perpendicular to a slice plane indicated by slice images constituting the three-dimensional MRI image for learning MR0. As a result, image information of adjacent slice images is included in each slice image of the three-dimensional MRI image for learning MR0. Then, the degrader 40 extracts two-dimensional images from the blurred three-dimensional MRI image for learning MR0 at random intervals to derive a pseudo two-dimensional MRI image for learning MF0 in which the slices of the three-dimensional MRI image for learning MR0 are thinned out. For example, in a case in which the slice interval of the three-dimensional MRI image for learning MR0 is 1 mm, the slice images are thinned out to have a random slice interval, for example, 5 mm, 7 mm, and 10 mm, each time different learning is performed, and the pseudo two-dimensional MRI image for learning MF0 is derived.

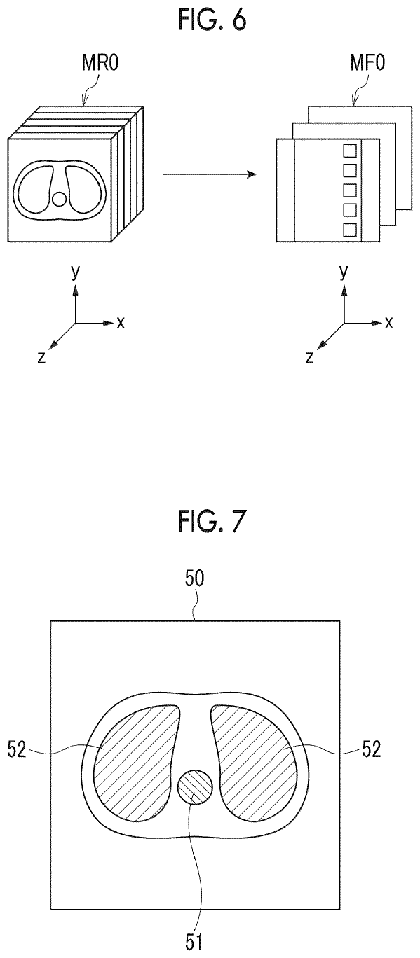

In a case of deriving the pseudo two-dimensional MRI image for learning MF0, the degrader 40 swaps the axes of the three-dimensional MRI image for learning MR0 such that a direction in which the slices are interpolated is the z axis, and then derives the pseudo two-dimensional MRI image for learning MF0. FIG. 6 is a diagram for describing swap of the axes. In general, in a three-dimensional image, a body axis direction of the subject is set to the z axis, a left-right direction is set to the x axis, and a front-back direction is set to the y axis. Therefore, in the three-dimensional MRI image for learning MR0 as well, the body axis direction of the subject is set to the z axis, the left-right direction is set to the x axis, and the front-back direction is set to the y axis. A slice plane perpendicular to the body axis is an axial plane, a slice plane in the left-right direction of the subject is a coronal plane, and a slice plane in the front-back direction of the subject is a sagittal plane.

For example, in a case of performing learning of interpolating slices of the sagittal plane for the three-dimensional MRI image for learning MR0, the degrader 40 derives the pseudo two-dimensional MRI image for learning MF0 by swapping axes such that a direction perpendicular to the sagittal plane is the z-axis, as shown in FIG. 6.

In a case of deriving the pseudo two-dimensional MRI image for learning MF0, the degrader 40 derives meta information MO. The meta information MO includes information on a slice plane (an axial plane, a coronal plane, and a sagittal plane) of the remaining slice images after thinning out some of the slice images, and information on a slice interval (5 mm, 7 mm, 10 mm, and the like).

The learning unit 22 inputs the pseudo two-dimensional MRI image for learning MF0 to the generator 41. In this case, the learning unit 22 may input the pseudo two-dimensional MRI image for learning MF0 to the generator 41 as it is, or may perform an interpolation operation on the pseudo two-dimensional MRI image for learning MF0 so that the slice interval of the pseudo three-dimensional image output by the generator 41, that is, by the first slice interpolation model 31 matches or approximates the slice interval of the pseudo two-dimensional MRI image for learning MF0. For example, it is assumed that the slice interval of the pseudo two-dimensional MRI image for learning MF0 is 5 mm and the slice interval of the pseudo three-dimensional image output by the first slice interpolation model 31 is 1 mm. In this case, the learning unit 22 interpolates the slices of the pseudo two-dimensional MRI image for learning MF0 through an interpolation operation such as linear interpolation or spline interpolation such that the slice interval of the pseudo two-dimensional MRI image for learning MF0 is 1 mm or approximated to 1 mm, and derives an interpolated pseudo two-dimensional MRI image for learning MF1.

As a result, even in a case in which a two-dimensional MRI image with an unknown slice interval is input, the second slice interpolation model can be constructed such that the slice interval can be uniformly handled.

The learning unit 22 inputs the interpolated pseudo two-dimensional MRI image for learning MF1 and the meta information MO to the generator 41, and causes the generator 41 to output a pseudo three-dimensional MRI image for learning MF2 obtained by interpolating the slices of the pseudo two-dimensional MRI image for learning MF1. Only the pseudo two-dimensional MRI image for learning MF1 may be input to the generator 41 to cause the generator 41 to output the pseudo three-dimensional MRI image for learning MF2.

Here, the interpolated pseudo two-dimensional MRI image for learning MF1 to be input to the generator 41 may be obtained by isotropically adjusting a physical size, performing random data augmentation processing such as posture conversion and enlargement and reduction, and then cutting out a fixed-size region from the processed image.

In addition, the slice interval of the pseudo two-dimensional MRI image for learning MF1, which has been interpolated as described above, may be the same as the slice interval of the pseudo three-dimensional MRI image for learning MF2. However, in the pseudo two-dimensional MRI image for learning MF1, the slices are interpolated by the interpolation operation. Therefore, even in a case in which the slice interval is the same, the resolution of the image in a slice direction (that is, a direction perpendicular to the slice plane) is higher in the pseudo three-dimensional MRI image for learning MF2 than in the pseudo two-dimensional MRI image for learning MF1.

The discriminator 42 is composed of, for example, a convolutional neural network, and, in a case in which a combination of the pseudo three-dimensional MRI image for learning MF2 and the meta information MO or a combination of the three-dimensional MRI image for learning MR0 and the meta information MO is input to the discriminator 42, the discriminator 42 discriminates whether the input image is an actual image or a pseudo image and outputs a discrimination result RF1. In this case, the actual image is the three-dimensional MRI image for learning MR0, and the pseudo image is the pseudo three-dimensional MRI image for learning MF2.

In a case in which the discriminator 42 receives the three-dimensional MRI image for learning MR0, which is an actual image, and discriminates that the input image is an actual image, the discrimination result RF1 is a correct answer. On the other hand, in a case in which the discriminator 42 receives the three-dimensional MRI image for learning MR0, which is an actual image, and discriminates that the received image is a pseudo image, that is, the pseudo three-dimensional MRI image for learning MF2 derived by the generator 41, the discrimination result RF1 is an incorrect answer. In addition, in a case in which the discriminator 42 discriminates that the received pseudo image is an actual image, the discrimination result RF1 is an incorrect answer, and, in a case in which the discriminator 42 discriminates that the received pseudo image is a pseudo image, the discrimination result RF1 is a correct answer.

The learning unit 22 derives a loss L1 based on the discrimination result RF1 output by the discriminator 42. In the present embodiment, the learning unit 22 trains the discriminator 42 to correct the discrimination result RF1 as to whether the input image is an actual image or a pseudo image derived by the generator 41. Specifically, the convolutional neural network constituting the discriminator 42 is trained such that the loss L1 is equal to or less than a predetermined threshold value.

In addition, the learning unit 22 derives a pseudo image, that is, the pseudo three-dimensional MRI image for learning MF2 from the input actual image, that is, from the pseudo two-dimensional MRI image for learning MF1, and trains the generator 41 such that the discriminator 42 discriminates the discrimination result RF1 as an incorrect answer. Specifically, the convolutional neural network constituting the generator 41 is trained such that the loss L1 is equal to or less than a predetermined threshold value. The first slice interpolation model 31 serving as the generator 41 has already been constructed for the CT image. Therefore, the learning unit 22 performs transfer learning such that the first slice interpolation model 31 corresponds to the MRI image.

As the learning progresses, the generator 41 and the discriminator 42 improve the accuracy, so that in a case in which the three-dimensional MRI image is input, the discriminator 42 can more accurately discriminate whether the input three-dimensional MRI image is an actual image or a pseudo image. Meanwhile, the generator 41 can generate a pseudo image that is not discriminated by the discriminator 42 and that is closer to the three-dimensional MRI image, which is an actual image, by performing slice interpolation on the two-dimensional MRI image. By proceeding with the learning in this manner, the generator 41 is constructed as the second slice interpolation model.

In addition, in performing transfer learning on the second slice interpolation model, a frequency of using the three-dimensional MRI image for learning MR0 may be changed according to a direction of a slice plane of the three-dimensional MRI image for learning MR0. For example, in a medical field, a slice image of an axial plane is most frequently used. Therefore, transfer learning may be performed on the second slice interpolation model by using more the three-dimensional MRI image for learning MR0 with the axial plane as the slice plane than the three-dimensional MRI image for learning MR0 with the coronal plane or the sagittal plane as the slice plane.

In addition, in performing transfer learning on the second slice interpolation model, a segmentation model generated as described below may be used. The segmentation model is constructed by learning to segment the anatomical structure included in the three-dimensional MRI image. The segmentation model extracts an anatomical structure from the input three-dimensional MRI image, segments which organ the extracted anatomical structure is, and derives a segmentation result of the anatomical structure. The segmentation result represents the anatomical structure of each pixel in the input image, and the segmentation model derives a mask representing the segmentation result of the anatomical structure by labeling pixels segmented into the same anatomical structure. FIG. 7 is a diagram showing the mask. A mask 50 shown in FIG. 7 is an axial image of the chest, and a label 51 is assigned to the heart, which is the anatomical structure segmented by the segmentation model, and a label 52 is assigned to the lung. The mask includes at least any of a mask image indicating a label assigned for each of position coordinates of the pixel, a composite image obtained by combining a modality image generated by a signal value detected by the modality for each of the position coordinates of the pixel and the mask image, or a superimposed image obtained by superimposing the modality image and the mask image.

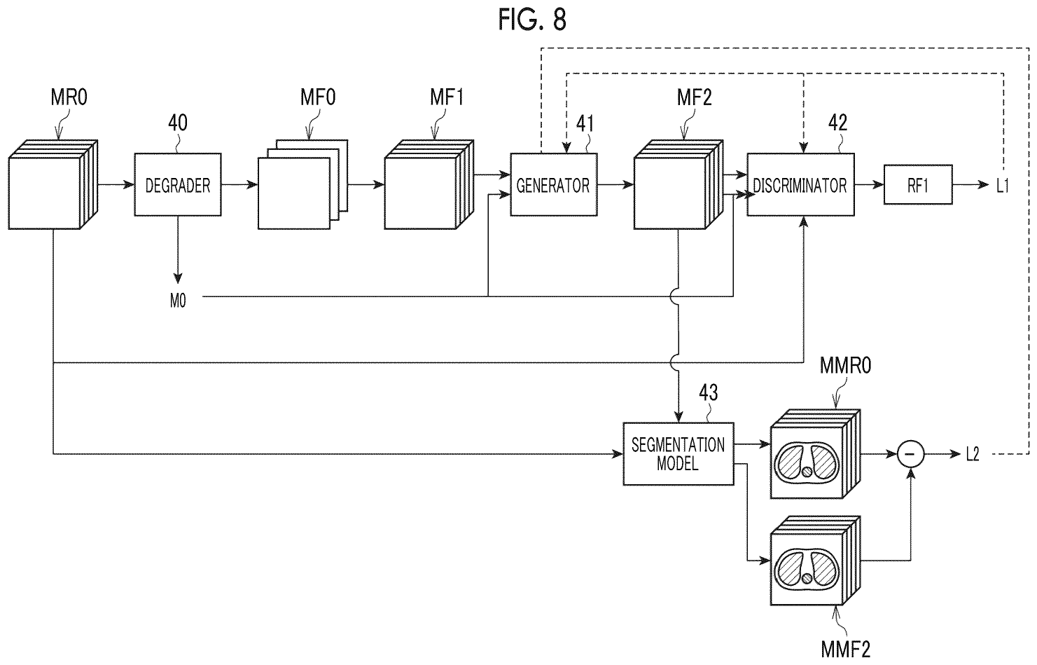

FIG. 8 is a diagram for describing learning for constructing the second slice interpolation model using the segmentation model. As shown in FIG. 8, in order to construct the second slice interpolation model, a segmentation model 43 is used in addition to the degrader 40, the generator 41, and the discriminator 42. Since the degrader 40, the generator 41, and the discriminator 42 are the same as those shown in FIG. 5, detailed description thereof will be omitted here.

In a case in which the three-dimensional MRI image for learning MR0 is input, the segmentation model 43 derives a segmentation result of the anatomical structure by segmenting the anatomical structure included in the three-dimensional MRI image for learning MR0. Further, the segmentation model 43 derives a mask MMR0 representing the segmentation result of the anatomical structure by labeling pixels segmented into the same anatomical structure. In addition, in a case in which the pseudo three-dimensional MRI image for learning MF2 output by the generator 41 based on the three-dimensional MRI image for learning MR0 is input, the segmentation model 43 derives a segmentation result of the anatomical structure by segmenting the anatomical structure included in the pseudo three-dimensional MRI image for learning MF2. Further, the segmentation model 43 derives a mask MMF2 representing the segmentation result of the anatomical structure by labeling pixels segmented into the same anatomical structure. The mask MMR0 is an example of a first segmentation result of the present disclosure, and the mask MMF2 is an example of a second segmentation result of the present disclosure.

The learning unit 22 derives a difference between the mask MMR0 and the mask MMF2 as a loss L2. Then, the learning unit 22 performs transfer learning on the generator 41 such that both the loss L1 and the loss L2 are small. That is, transfer learning is performed on the generator 41 such that each of the loss L1 and the loss L2 is less than a predetermined threshold value, and the second slice interpolation model is constructed.

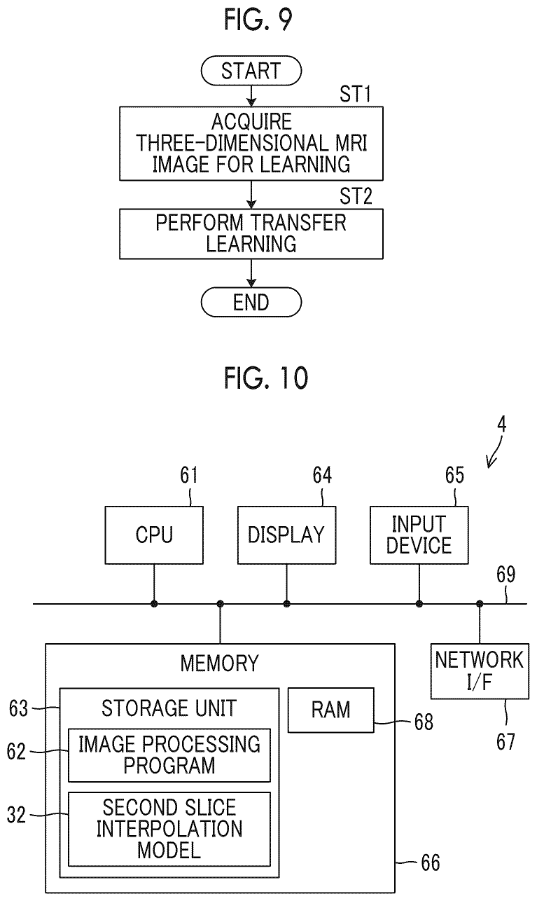

Next, processing performed by the learning device according to the present embodiment will be described. FIG. 9 is a flowchart showing the processing performed by the learning device according to the present embodiment. First, the information acquisition unit 21 acquires the three-dimensional MRI image for learning MR0 from the image storage server 3 (step ST1). Then, the learning unit 22 performs transfer learning on the generator 41, that is, the first slice interpolation model 31 based on the three-dimensional MRI image for learning MR0 to construct the second slice interpolation model (step ST2), and the processing is ended.

As described above, in the learning device according to the present embodiment, transfer learning is performed on the first slice interpolation model 31 using the three-dimensional MRI image for learning MR0 to construct the second slice interpolation model for generating the pseudo three-dimensional MRI image by performing the slice interpolation on the two-dimensional MRI image. Therefore, even though a two-dimensional MRI image is available for a part other than the specific part for which the three-dimensional MRI image exists, a pseudo three-dimensional MRI image for the part other than the specific part can be acquired.

In addition, by swapping the axes of the pseudo two-dimensional image for learning MF0 in accordance with the axes in the direction of the slice interpolation on the pseudo two-dimensional image for learning MF0 and inputting the pseudo two-dimensional image for learning MF0 with the swapped axes to the first slice interpolation model 31, that is, the generator 41, the pseudo two-dimensional MRI image for learning MF1 can be input to the generator 41 in accordance with a direction in which the first slice interpolation model 31 performs the slice interpolation processing. Therefore, the transfer learning on the generator 41 can be efficiently performed.

In addition, by deriving the pseudo two-dimensional MRI image for learning MF0 in which the slice interval is randomly changed from the three-dimensional MRI image for learning MR0, the transfer learning on the first slice interpolation model 31 can be performed so that the pseudo three-dimensional MRI image can be derived from the two-dimensional MRI images having various slice intervals.

In addition, by including information indicating the slice plane of the three-dimensional MRI image for learning MR0 in the meta information MO during learning and inputting the information to the generator 41 and/or the discriminator 42, the transfer learning of the generator 41, that is, the first slice interpolation model 31 can be performed such that the pseudo three-dimensional MRI image that takes into account the feature of the slice plane can be derived.

In addition, by using the segmentation model to derive the mask MMR0 for the three-dimensional MRI image for learning MR0 and the mask MMF2 for the pseudo three-dimensional MRI image for learning MF2, and performing transfer learning such that the difference between mask MMR0 and mask MMF2 is small, the second slice interpolation model 32 can be constructed to derive a pseudo three-dimensional MRI image that is closer to the actual image.

Next, the image processing apparatus according to the present disclosure will be described. FIG. 10 is a diagram showing a hardware configuration of the image processing apparatus according to the present embodiment. As shown in FIG. 10, the image processing apparatus 4 includes a CPU 61, a display 64, an input device 65, a memory 66, and a network I/F 67 connected to a network. The CPU 61, the display 64, the input device 65, the memory 66, and the network I/F 67 are connected to a bus 69. The memory 66 includes a storage unit 63 and a RAM 68. The CPU 61 is an example of a processor in the present disclosure. The CPU 61, the display 64, the input device 65, the memory 66, and the network I/F 67 correspond to the CPU 11, the display 14, the input device 15, the memory 16, and the network I/F 17 shown in FIG. 2, so that detailed description thereof will be omitted here. The storage unit 63 stores the image processing program 62 according to the present embodiment and the second slice interpolation model 32 constructed by the learning device 1 according to the present embodiment.

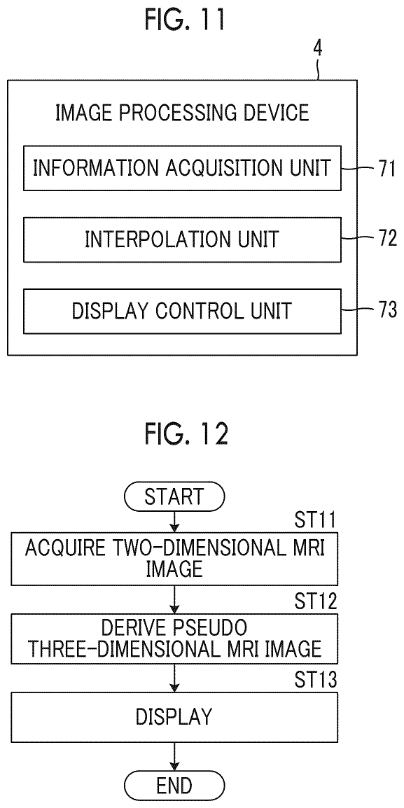

FIG. 11 is a diagram showing the functional configuration of the image processing apparatus according to the present embodiment. As shown in FIG. 11, the image processing apparatus 4 according to the present embodiment comprises an information acquisition unit 71, an interpolation unit 72, and a display control unit 73. By executing the image processing program 62 by the CPU 61, the CPU 61 functions as the information acquisition unit 71, the interpolation unit 72, and the display control unit 73.

The information acquisition unit 71 acquires the two-dimensional image in the second expression format to be processed, from the image storage server 3 via the network 5. In the present embodiment, a two-dimensional MRI image is acquired.

The interpolation unit 72 derives a pseudo three-dimensional MRI image by performing slice interpolation on the two-dimensional MRI image using the second slice interpolation model 32 constructed by the learning device 1 according to the present embodiment. In this case, the two-dimensional MRI image may be input to the second slice interpolation model 32 as it is, but the two-dimensional MRI image may be subjected to an interpolation operation to match the slice interval of the pseudo three-dimensional MRI image output by the second slice interpolation model 32, as in the training of the second slice interpolation model 32, and the interpolated two-dimensional MRI image may be input to the second slice interpolation model 32. The derived pseudo three-dimensional MRI image is transmitted to the image storage server 3 via the network 5 and is stored therein.

The display control unit 73 displays the pseudo three-dimensional MRI image derived by the interpolation unit 72 on the display 64.

Next, processing performed in the image processing apparatus according to the present embodiment will be described. FIG. 12 is a flowchart showing the processing performed by the image processing apparatus according to the present embodiment. First, the information acquisition unit 71 acquires the two-dimensional MRI image to be processed (Step ST11). Then, the interpolation unit 72 derives the pseudo three-dimensional MRI image from the two-dimensional MRI image using the second slice interpolation model 32 (step ST12). Then, the display control unit 73 displays the pseudo three-dimensional MRI image on the display 64 (step ST13), and the processing is ended.

As described above, the image processing apparatus 4 according to the present embodiment derives the pseudo three-dimensional MRI image from the two-dimensional MRI image by using the second slice interpolation model 32 constructed by the learning device 1 according to the present embodiment. Therefore, it is possible to acquire the pseudo three-dimensional MRI image that is comparable to an actual image.

It is possible to construct an analysis device that analyzes the pseudo three-dimensional MRI image derived by the image processing apparatus 4 according to the present embodiment. For example, an analysis device that extracts a blood vessel included in an MRI image can be applied to the pseudo three-dimensional MRI image. In this case, since the interval in the slice direction of the two-dimensional MRI image is large, there is a high possibility that the blood vessel cannot be continuously extracted. By using the pseudo three-dimensional MRI image derived by the image processing apparatus 4 according to the present embodiment, it is possible to continuously extract the blood vessel.

Next, the learning device for constructing the above-described segmentation model will be described as another learning device. As described above, the segmentation model is for segmenting the anatomical structure included in the three-dimensional MRI image.

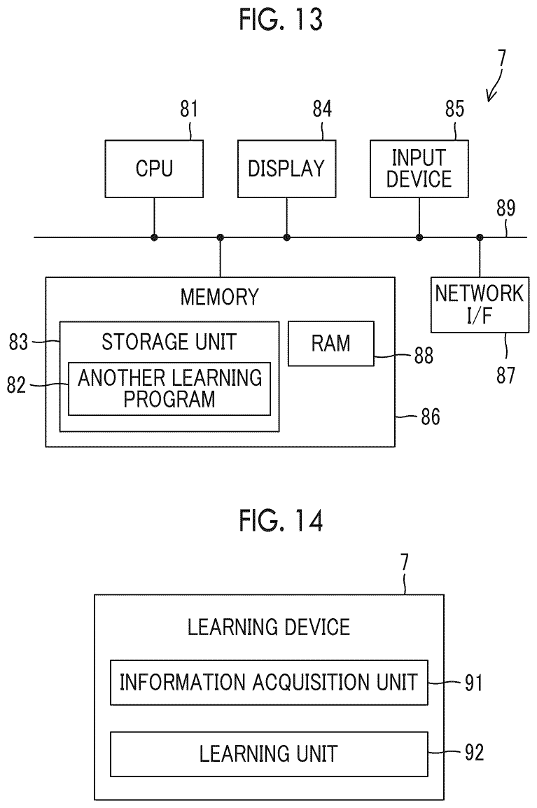

FIG. 13 is a diagram showing a hardware configuration of another learning device according to the present embodiment. As shown in FIG. 13, another learning device 7 includes a CPU 81, a display 84, an input device 85, a memory 86, and a network I/F 87 connected to a network. The CPU 81, the display 84, the input device 85, the memory 86, and the network I/F 87 are connected to a bus 89. The memory 86 includes a storage unit 83 and a RAM 88. The CPU 81 is an example of a processor in the present disclosure. The CPU 81, the display 84, the input device 85, the memory 86, and the network I/F 87 correspond to the CPU 11, the display 14, the input device 15, the memory 16, and the network I/F 17 shown in FIG. 2, so that detailed description thereof will be omitted here. In addition, the storage unit 83 stores another learning program 82 according to the present embodiment.

FIG. 14 is a diagram showing a functional configuration of still another learning device according to the present embodiment. As shown in FIG. 14, the other learning device 7 according to the present embodiment comprises an information acquisition unit 91 and a learning unit 92. In a case in which the CPU 81 executes the other learning program 82, the CPU 81 functions as the information acquisition unit 91 and the learning unit 92.

The information acquisition unit 91 acquires learning data for use in learning from the image storage server 3 via the network 5. The other learning device 7 according to the present embodiment constructs a segmentation model for segmenting the anatomical structure included in the three-dimensional MRI image as described above. Therefore, the information acquisition unit 91 acquires, as first learning data 101, a pair formed of an actual three-dimensional MRI image MR5, which is an actual image acquired by three-dimensionally imaging the subject using the MRI apparatus, and a mask MMR5 derived based on an actual three-dimensional MRI image MR5. In addition, the information acquisition unit 91 acquires, as second learning data 102, a pair formed of a pseudo three-dimensional MRI image MF5 derived by the image processing apparatus 4 according to the present embodiment, and a mask MMF5 acquired based on the pseudo three-dimensional MRI image MF5.

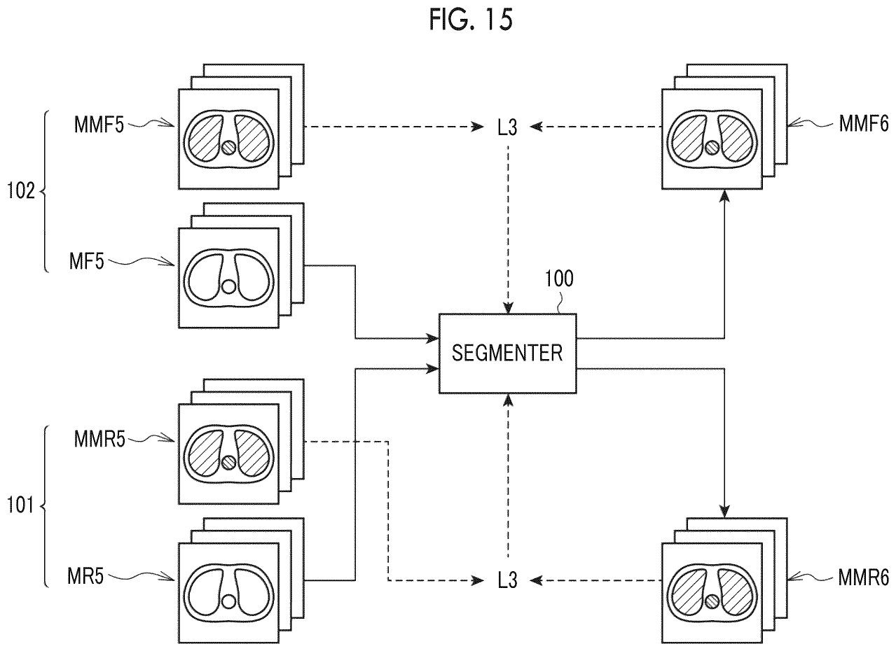

The learning unit 92 trains a segmenter in order to construct a segmentation model for segmenting the anatomical structure included in the image. FIG. 15 is a diagram for describing training of a segmenter for constructing the segmentation model. A segmenter 100 is composed of, for example, a two-dimensional convolutional neural network and segments the anatomical structure included in the input image. The segmenter 100 performs processing of deriving a probability of being an anatomical structure for each of various anatomical structures included in the input image and segmenting an anatomical structure whose probability is equal to or greater than a threshold value as the anatomical structure. The segmenter 100 derives a mask representing the segmentation result of the anatomical structure by labeling pixels segmented into the same anatomical structure. The first learning data 101 and the second learning data 102 acquired by the information acquisition unit 91 are used for training the segmenter 100.

In learning, the learning unit 92 inputs the actual three-dimensional MRI image MR5 of the first learning data 101 to the segmenter 100, and derives a mask MMR6 representing a segmentation result of the anatomical structure. In addition, the learning unit 92 inputs the pseudo three-dimensional MRI image MF5 of the second learning data 102 to the segmenter 100, and derives a mask MMF6 representing a segmentation result of the anatomical structure. Then, the learning unit 92 derives a difference between the mask MMR5 and the mask MMR6 and a difference between the mask MMF5 and the mask MMF6 as a loss L3, and trains the segmenter 100 such that the loss L3 is equal to or less than a predetermined threshold value, thereby constructing a segmentation model.

The loss L3 can be derived by, for example, Equation (1) or Equation (2). Correct answer data is data of the mask MMR5 or the mask MMF5, and inference data is data of the mask MMR6 or the mask MMF6. Equation (1) is a binary cross-entropy loss, and Equation (2) is a means square error (MSE). In Equations (1) and (2), a left side is the loss L3. In addition, in Equations (1) and (2), in a case in which the loss for the mask MMR6 derived based on the actual three-dimensional MRI image MR5, which is an actual image, is derived, a weight wi is set to be larger than in a case in which the loss for the mask MMF6 derived based on the pseudo three-dimensional MRI image MF5 is derived. As a result, the segmenter 100 can be trained to perform segmentation with higher accuracy.

$$Loss ( y , \hat{y} ) = - \sum {w}_{i} ( {y}_{i} log ( {\hat{y}}_{i} ) + ( 1 - {y}_{i} ) log ( 1 - {\hat{y}}_{i} ) ) \qquad ( 1 )$$

$$Loss ( y , \hat{y} ) = \frac{1}{n} \sum {{w}_{i} ( {y}_{i} - {\hat{y}}_{i} )}^{2} \qquad ( 2 )$$

yᵢ is correct answer data, ŷᵢ is inference data, wᵢ eight of i-th sample, and R is the number of samples.

In a case of performing the multi-class segmentation, the loss L3 may be derived using Equation (3). In Equation (3), j represents different classes (for example, a heart and a lung), and wij is a weight for a j-th class of an i-th sample.

$$Loss ( y , \hat{y} ) = - \sum \sum {w}_{ij} {y}_{i} log ( {\hat{y}}_{i} ) \qquad ( 3 )$$

In addition, in a case of training the segmenter 100, it is preferable to use the actual three-dimensional MRI image MR5, which is an actual image, more than the pseudo three-dimensional MRI image MF5, which is a pseudo image, in order to improve the training accuracy.

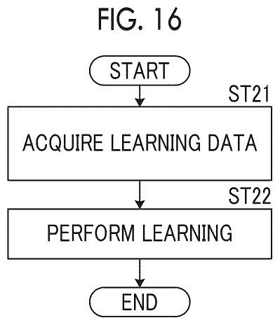

Next, processing performed by the other learning device 7 according to the present embodiment will be described. FIG. 16 is a flowchart showing the processing performed by the other learning device according to the present embodiment. First, the information acquisition unit 91 acquires the first learning data 101 and the second learning data 102 from the image storage server 3 (learning data acquisition: step ST21). Next, the learning unit 92 constructs a segmentation model by training the segmenter 100 using the first learning data 101 and the second learning data 102 (step ST22), and the processing is ended.

As described above, in the other learning device 7 according to the present embodiment, the pseudo three-dimensional MRI image derived by the image processing apparatus 1 according to the present embodiment is used as the learning data. As a result, the amount of the learning data can be increased, so that a segmentation model for segmenting the anatomical structure included in the image can be constructed with high accuracy.

In the embodiment of the other learning device, the first learning data 101 and the second learning data 102 are used for training the segmenter 100, but the present invention is not limited to this. The segmenter may be trained using only the second learning data 102 including the pseudo three-dimensional MRI image derived by the image processing apparatus 1 according to the present embodiment.

In this embodiment, each process is executed on an arbitrary computer. The arbitrary computer may execute these processes by means of a processor as hardware, a program as software, or a combination of the processor and the program. In such a case, the processor is configured to execute the various processes in this embodiment in cooperation with the program and may function as each unit or means in this embodiment. In addition, the order in which the processor executes these processes is not limited to the order described in this embodiment and may be changed as appropriate. The arbitrary computer may be a general-purpose computer, a computer for a specific purpose, a workstation, or any other system capable of executing each process.

The processor may be configured by one or more hardware, and the type of hardware is not limited. For example, the processor may comprise at least one of programmable logic devices such as CPUs (Central Processing Units), MPUs (Micro Processing Units), and FPGAs (Field Programmable Gate Arrays); dedicated circuits for performing specific processes such as ASICs (Application Specific Integrated Circuits); and other hardware such as a GPU (Graphics Processing Unit) and an NPU (Neural Processing Unit). The hardware may also be a combination of different types of hardware. When multiple hardware are configured to execute one or more processes of a processor, the said multiple hardware may exist in devices that are physically separate from each other, or in the same device. In any embodiment, the order of each process by the processor is not limited to the order described above and may be changed as appropriate. The hardware is configured by an electric circuit (circuitry) etc. that combines circuit elements such as semiconductor devices.

Furthermore, the program may be firmware or software such as microcode. The program may also be a group of program modules, each function of which may be performed by a processor configured to execute each of the program modules. The program may be program code or code segments stored on one or more non-transitory computer-readable media (e.g., storage media or other storage). The program may be stored in separate non-transitory computer-readable media located on devices that are physically separate from each other. The program code or code segments may represent any combination of procedures, functions, subprograms, routines, subroutines, modules, software packages, classes, instructions, data structures, or program statements. The program code or code segments may be connected to other code segments or hardware circuits by sending or receiving information, data, arguments, parameters, or memory contents.

In the above embodiment, it is explained that the learning program 12 is stored (installed) in advance in the storage unit 13, and a image processing program 62 is stored (installed) in advance in the storage unit 63, but this is not limited to this. The learning program 12 and the image processing program 62 may be provided in a form recorded on a recording medium such as a CD-ROM (Compact Disc Read Only Memory), DVD-ROM (Digital Versatile Disc Read Only Memory), and USB (Universal Serial Bus) memory. In addition, the learning program 12 and the image processing program 62 may be provided in a form that the learning program 12 and the image processing program 62 are downloaded from an external device via a network.

The technology of this disclosure also extends to all types of program products. Program products include all types of products for providing programs. For example, program products include programs provided via networks such as the Internet, and non-temporary computer readable storage media such as CD-ROMs, DVDs, and USB memory devices that store programs.

Appendices of the present disclosure will be described below.

### APPENDIX 1

A learning device comprising:
a processor,
in which the processor performs transfer learning on a first slice interpolation model for generating, in response to input of a two-dimensional image in a first expression format consisting of a plurality of slice images, the two-dimensional image being acquired by two-dimensionally imaging a first range of a subject, a pseudo three-dimensional image in the first expression format by performing slice interpolation on the two-dimensional image in the first expression format by using a three-dimensional image for learning in a second expression format acquired by three-dimensionally imaging a second range narrower than the first range, to construct a second slice interpolation model for generating, in response to input of a two-dimensional image in the second expression format, a pseudo three-dimensional image in the second expression format by performing slice interpolation on the two-dimensional image in the second expression format.

### APPENDIX 2

The learning device according to Appendix 1,
in which the processor derives a pseudo two-dimensional image for learning in which slices of the three-dimensional image for learning is reduced, inputs the pseudo two-dimensional image for learning to the first slice interpolation model to cause the first slice interpolation model to output a pseudo three-dimensional image for learning, and performs the transfer learning based on a difference between the three-dimensional image for learning and the pseudo three-dimensional image for learning.

### APPENDIX 3

The learning device according to Appendix 2,
in which the processor swaps an axis of the pseudo two-dimensional image for learning in accordance with an axis in a direction of the slice interpolation on the pseudo two-dimensional image for learning, and inputs the pseudo two-dimensional image for learning with the swapped axis to the first slice interpolation model.

### APPENDIX 4

The learning device according to Appendix 2 or 3,
in which the processor derives the pseudo two-dimensional image for learning in which a slice interval is randomly changed from the three-dimensional image for learning.

### APPENDIX 5

The learning device according to any one of Appendices 1 to 4,
in which the processor uses a discriminator for discriminating whether the three-dimensional image for learning is an actual image or a pseudo image to perform adversarial learning on the discriminator and the first slice interpolation model.

### APPENDIX 6

The learning device according to Appendix 5,
in which the processor inputs information indicating a slice plane of the three-dimensional image for learning to at least one of the first slice interpolation model or the discriminator.

### APPENDIX 7

The learning device according to any one of Appendices 1 to 6,
in which the processor changes a frequency of using the three-dimensional image for learning for the transfer learning according to a direction of a slice plane of the three-dimensional image for learning.

### APPENDIX 8

The learning device according to any one of Appendices 1 to 7,
in which the processor
   derives a first segmentation result for the three-dimensional image for learning using a segmentation model for segmenting an anatomical structure included in a three-dimensional image in the second expression format,
   derives a second segmentation result for a pseudo three-dimensional image for learning derived by the first slice interpolation model based on the three-dimensional image for learning using the segmentation model, and
   performs the transfer learning such that a difference between the first segmentation result and the second segmentation result is small.

### APPENDIX 9

An image processing apparatus comprising:
a processor,
in which the processor uses the second slice interpolation model constructed by the learning device according to any one of Appendices 1 to 8 to derive the pseudo three-dimensional image in the second expression format from the two-dimensional image in the second expression format.

### APPENDIX 10

The image processing apparatus according to Appendix 9,
in which the processor
   performs an interpolation operation of matching a slice interval of the two-dimensional image in the second expression format with a slice interval of the pseudo three-dimensional image, and
   derives the pseudo three-dimensional image by inputting the two-dimensional image on which the interpolation operation is performed to the second slice interpolation model.

### APPENDIX 11

A learning device that performs learning for constructing a segmentation model for segmenting an anatomical structure included in a three-dimensional image in a second expression format, the learning device comprising:
a processor,
in which the processor performs the learning using the pseudo three-dimensional image derived by the image processing apparatus according to Appendix 9 or 10 as learning data.

### APPENDIX 12

The learning device according to Appendix 11,
in which the processor further uses an actual three-dimensional image in the second expression format acquired by imaging as the learning data to perform the learning.

### APPENDIX 13

The learning device according to Appendix 12,
in which the processor performs the learning using the actual three-dimensional image in the learning more frequently than the pseudo three-dimensional image.

### APPENDIX 14

The learning device according to Appendix 12 or 13,
in which the processor weights the actual three-dimensional image more heavily than the pseudo three-dimensional image in a case in which the actual three-dimensional image and the pseudo three-dimensional image are used in the learning.

### APPENDIX 15

An analysis device that analyzes the pseudo three-dimensional image derived by the image processing apparatus according to Appendix 9 or 10.

### APPENDIX 16

A learning method comprising:
causing a computer to execute performing transfer learning on a first slice interpolation model for generating, in response to input of a two-dimensional image in a first expression format consisting of a plurality of slice images, the two-dimensional image being acquired by two-dimensionally imaging a first range of a subject, a pseudo three-dimensional image in the first expression format by performing slice interpolation on the two-dimensional image in the first expression format by using a three-dimensional image for learning in a second expression format acquired by three-dimensionally imaging a second range narrower than the first range, to construct a second slice interpolation model for generating, in response to input of a two-dimensional image in the second expression format, a pseudo three-dimensional image in the second expression format by performing slice interpolation on the two-dimensional image in the second expression format.

### APPENDIX 17

An image processing method comprising:
causing a computer to execute using the second slice interpolation model constructed by the learning device according to any one of Appendices 1 to 8 to derive the pseudo three-dimensional image in the second expression format from the two-dimensional image in the second expression format.

### APPENDIX 18

A learning program causing a computer to execute:
a procedure of performing transfer learning on a first slice interpolation model for generating, in response to input of a two-dimensional image in a first expression format consisting of a plurality of slice images, the two-dimensional image being acquired by two-dimensionally imaging a first range of a subject, a pseudo three-dimensional image in the first expression format by performing slice interpolation on the two-dimensional image in the first expression format by using a three-dimensional image for learning in a second expression format acquired by three-dimensionally imaging a second range narrower than the first range, to construct a second slice interpolation model for generating, in response to input of a two-dimensional image in the second expression format, a pseudo three-dimensional image in the second expression format by performing slice interpolation on the two-dimensional image in the second expression format.

### APPENDIX 19

An image processing program causing a computer to execute:
a procedure of using the second slice interpolation model constructed by the learning device according to any one of Appendices 1 to 8 to derive the pseudo three-dimensional image in the second expression format from the two-dimensional image in the second expression format.

What is claimed is:

1. A learning device comprising:
a processor,
wherein the processor performs transfer learning on a first slice interpolation model for generating, in response to input of a two-dimensional image in a first expression format consisting of a plurality of slice images, the two-dimensional image being acquired by two-dimensionally imaging a first range of a subject, a pseudo three-dimensional image in the first expression format by performing slice interpolation on the two-dimensional image in the first expression format by using a three-dimensional image for learning in a second expression format acquired by three-dimensionally imaging a second range narrower than the first range, to construct a second slice interpolation model for generating, in response to input of a two-dimensional image in the second expression format, a pseudo three-dimensional image in the second expression format by performing slice interpolation on the two-dimensional image in the second expression format.

2. The learning device according to claim 1,
wherein the processor derives a pseudo two-dimensional image for learning in which slices of the three-dimensional image for learning is reduced, inputs the pseudo two-dimensional image for learning to the first slice interpolation model to cause the first slice interpolation model to output a pseudo three-dimensional image for learning, and performs the transfer learning based on a difference between the three-dimensional image for learning and the pseudo three-dimensional image for learning.

3. The learning device according to claim 2,
wherein the processor swaps an axis of the pseudo two-dimensional image for learning in accordance with an axis in a direction of the slice interpolation on the pseudo two-dimensional image for learning, and inputs the pseudo two-dimensional image for learning with the swapped axis to the first slice interpolation model.

4. The learning device according to claim 2,
wherein the processor derives the pseudo two-dimensional image for learning in which a slice interval is randomly changed from the three-dimensional image for learning.

5. The learning device according to claim 1,
wherein the processor uses a discriminator for discriminating whether the three-dimensional image for learning is an actual image or a pseudo image to perform adversarial learning on the discriminator and the first slice interpolation model.

6. The learning device according to claim 5,
wherein the processor inputs information indicating a slice plane of the three-dimensional image for learning to at least one of the first slice interpolation model or the discriminator.

7. The learning device according to claim 1,
wherein the processor changes a frequency of using the three-dimensional image for learning for the transfer learning according to a direction of a slice plane of the three-dimensional image for learning.

8. The learning device according to claim 1,
wherein the processor
derives a first segmentation result for the three-dimensional image for learning using a segmentation model for segmenting an anatomical structure included in a three-dimensional image in the second expression format,
derives a second segmentation result for a pseudo three-dimensional image for learning derived by the first slice interpolation model based on the three-dimensional image for learning using the segmentation model, and
performs the transfer learning such that a difference between the first segmentation result and the second segmentation result is small.

9. An image processing apparatus comprising:
a processor,
wherein the processor uses the second slice interpolation model constructed by the learning device according to claim 1 to derive the pseudo three-dimensional image in the second expression format from the two-dimensional image in the second expression format.

10. The image processing apparatus according to claim 9,
wherein the processor
performs an interpolation operation of matching a slice interval of the two-dimensional image in the second expression format with a slice interval of the pseudo three-dimensional image, and
derives the pseudo three-dimensional image by inputting the two-dimensional image on which the interpolation operation is performed to the second slice interpolation model.

11. A learning device that performs learning for constructing a segmentation model for segmenting an anatomical structure included in a three-dimensional image in a second expression format, the learning device comprising:
a processor,
wherein the processor performs the learning using the pseudo three-dimensional image derived by the image processing apparatus according to claim 9 as learning data.

12. The learning device according to claim 11,
wherein the processor further uses an actual three-dimensional image in the second expression format acquired by imaging as the learning data to perform the learning.

13. The learning device according to claim 12,
wherein the processor performs the learning using the actual three-dimensional image in the learning more frequently than the pseudo three-dimensional image.

14. The learning device according to claim 12,
wherein the processor weights the actual three-dimensional image more heavily than the pseudo three-dimensional image in a case in which the actual three-dimensional image and the pseudo three-dimensional image are used in the learning.

15. An analysis device that analyzes the pseudo three-dimensional image derived by the image processing apparatus according to claim 9.

16. A learning method comprising:
causing a computer to execute performing transfer learning on a first slice interpolation model for generating, in response to input of a two-dimensional image in a first expression format consisting of a plurality of slice images, the two-dimensional image being acquired by two-dimensionally imaging a first range of a subject, a pseudo three-dimensional image in the first expression format by performing slice interpolation on the two-dimensional image in the first expression format by using a three-dimensional image for learning in a second expression format acquired by three-dimensionally imaging a second range narrower than the first range, to construct a second slice interpolation model for generating, in response to input of a two-dimensional image in the second expression format, a pseudo three-dimensional image in the second expression format by performing slice interpolation on the two-dimensional image in the second expression format.

17. An image processing method comprising:
causing a computer to execute using the second slice interpolation model constructed by the learning device according to claim 1 to derive the pseudo three-dimensional image in the second expression format from the two-dimensional image in the second expression format.

18. A non-transitory computer-readable storage medium that stores a learning program causing a computer to execute:
a procedure of performing transfer learning on a first slice interpolation model for generating, in response to input of a two-dimensional image in a first expression format consisting of a plurality of slice images, the two-dimensional image being acquired by two-dimensionally imaging a first range of a subject, a pseudo three-dimensional image in the first expression format by performing slice interpolation on the two-dimensional image in the first expression format by using a three-dimensional image for learning in a second expression format acquired by three-dimensionally imaging a second range narrower than the first range, to construct a second slice interpolation model for generating, in response to input of a two-dimensional image in the second expression format, a pseudo three-dimensional image in the second expression format by performing slice interpolation on the two-dimensional image in the second expression format.

19. A non-transitory computer-readable storage medium that stores an image processing program causing a computer to execute:
a procedure of using the second slice interpolation model constructed by the learning device according to claim 1 to derive the pseudo three-dimensional image in the second expression format from the two-dimensional image in the second expression format.
